(19) United States
(12) Patent Application Publication
(10) Pub. No.: US 2006/0225904 A1
(43) Pub. Date: Oct. 12, 2006

(54) Power tool that can interrupt the electric power automatically

(75) Inventor: Jui-Yu Chen, Anting (TW)

Correspondence Address: NIKOLAI & MERSEREAU, P.A., 900 SECOND AVENUE SOUTH, SUITE 820, MINNEAPOLIS, MN, 55402, US

(73) Assignee: Interflow Corp., Anting (TW)

(21) Appl. No.: 11/104,062

(22) Filed: Apr. 12, 2005

(51) Int. Cl. B23Q 5/00

(52) U.S. Cl. 173/176

(57) ABSTRACT

A power tool includes a control interface device to start the timing unit, so that the electric power from the power supply device is interrupted automatically and the motor stops operating when the preset time of the timing unit is reached so as to keep the output torque of the motor at a constant value exactly, thereby preventing from incurring errors of the manual control operation.

### BACKGROUND OF THE INVENTION

1. Field of the Invention

The present invention relates to a power tool, such as a motorized wrench or the like, and more particularly to a power tool that can interrupt the electric power automatically.

2. Description of the Related Art

A conventional motorized wrench in accordance with the prior art shown in FIG. 5 is used to mount and detach the screws of a tire and comprises a housing 1, a motor 11 mounted in the housing 1 and having an end provided with a drive gear 111, a main frame 12 mounted in the housing 1 and having a first side provided with a driven gear 121 meshing with and rotated by the drive gear 111 of the motor 11, an output shaft 13 mounted in the housing 1 and having a first end secured to a second side of the main frame 12 and a second end protruded from the housing 1 and formed with a mounting portion 131 for mounting the screws of a tire, a clutch device 14 mounted in the main frame 12, and a switch 15 mounted in the housing 1 to control operation of the motor 11. In operation, when the motorized wrench is connected to an electric power, the electric power drives the motor 11 to rotate through the switch 15. Then, the motor 11 rotates the drive gear 111 which rotates the driven gear 121. At this time, the clutch device 14 is operated by rotation of the driven gear 121 to convert the successive output force of the motor 11 into an intermittent output force to rotate the output shaft 13 and to produce a pressing force so as to mount and detach the screws.

Another conventional motorized wrench in accordance with the prior art shown in FIG. 6 is used to mount and detach the screws of a tire and comprises a housing 2, a motor 21 mounted in the housing 2, a pressing ring 22 mounted in the housing 2. In operation, when the motor 21 is rotated, the gear mechanism (not shown) mounted in the motor 21 compresses the spring 23 to produce a restoring force. When the spring 23 is released, the spring 23 produces a hit pressing force by its restoring force so as to mount and detach the screws.

In the above-mentioned motorized wrench, the motor is rotated at a high speed, thereby producing many striking times per second. In addition, the user employs the motorized wrench to mount and detach the screws by pressing the switch, so that the tightness of the screws is determined by the pressing time of the switch. Thus, the user often judges the output torque of the motor by experience. However, the motor is rotated at a high speed, so that the user cannot judge the exact output torque of the motor. Thus, when the output torque of the motor is too large, the screw of the tire is easily worn out or broken by the high speed rotation of the output shaft, and when the output torque of the motor is too small, the screw of the tire is easily loosened.

The closest prior art references of which the applicant is aware are disclosed in his U.S. Pat. Nos. 5,887,666; 6,119,794 and 6,283,226. However, In the above-mentioned prior art references, the tightness of the screw is also controlled and determined in a manual manner, so that the screw is easily too tightened or loosened.

### SUMMARY OF THE INVENTION

In accordance with the present invention, there is provided a power tool, comprising a housing, a motor mounted in the housing, an output shaft mounted in the housing, a driving device mounted in the housing and connected to the motor and the output shaft, a switch mounted on the housing, and a control interface device mounted between the motor and the switch. The control interface device starts a timing unit so that an electric power supplied to the motor is interrupted after a preset time of the timing unit is reached, and the motor stops operating. In addition, the preset time of the timing unit is proportional to an output torque of the motor.

Preferably, the preset time of the timing unit is adjusted by an adjusting knob so that the preset time of the timing unit is determined according to a user's practical requirement.

Preferably, the control interface device is available for a motorized wrench.

Preferably, the control interface device is available for a pneumatic wrench.

Preferably, the power tool further comprises an electromagnetic valve connected to the control interface device to drive the control interface device to start the timing unit so that the motor closes the electromagnetic valve after the preset time of the timing unit is reached to stop operation of the pneumatic wrench.

Preferably, the control interface device is available for other power tools.

The primary objective of the present invention is to provide a power tool that can interrupt the electric power automatically.

Another objective of the present invention is to provide a power tool, wherein the power tool comprises a control interface device to start the timing unit, so that the electric power from the power supply device is interrupted automatically and the motor stops operating when the preset time of the timing unit is reached so as to keep the output torque of the motor at a constant value exactly, thereby preventing from incurring errors of the manual control operation.

A further objective of the present invention is to provide a power tool, wherein the output torque of the motor is maintained at a constant value exactly, so that the screw of the tire is locked exactly by the constant output torque of the motor and will not be too tight or too loose, thereby preventing the tire from being worn out due to the screw of the tire being too tight or too loose so as to protect the drive's safety.

Further benefits and advantages of the present invention will become apparent after a careful reading of the detailed description with appropriate reference to the accompanying drawings.

### BRIEF DESCRIPTION OF THE DRAWINGS

FIG. 1 is a block diagram of a power tool in accordance with the preferred embodiment of the present invention;

FIG. 2 is a circuit layout of the power tool as shown in FIG. 1;

FIG. 3 is a plan cross-sectional view of the power tool in accordance with the preferred embodiment of the present invention;

FIG. 4 is a block diagram of a power tool in accordance with another preferred embodiment of the present invention;

FIG. 5 is a plan cross-sectional view of a conventional power tool in accordance with the prior art; and

FIG. 6 is a plan cross-sectional view of another conventional power tool in accordance with the prior art.

### DETAILED DESCRIPTION OF THE INVENTION

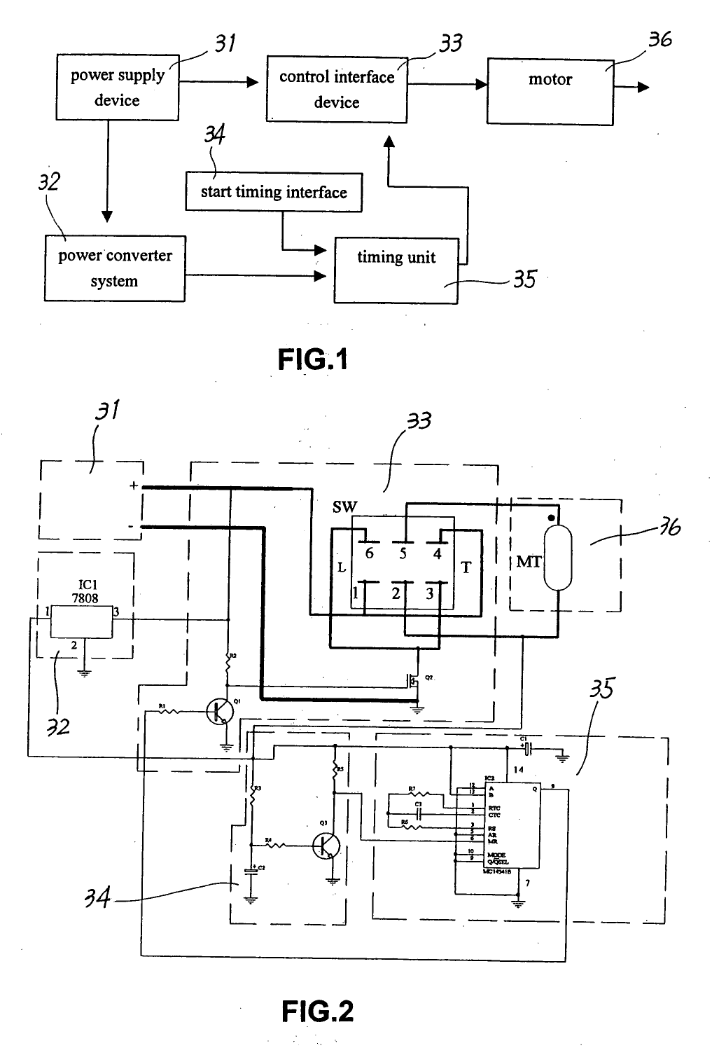

Referring to the drawings and initially to FIG. 1, a power tool, such as a motorized wrench, in accordance with the preferred embodiment of the present invention comprises a power supply device 31, a timing unit 35, and a power converter system 32 connected to the power supply device 31 and the timing unit 35 to drop the voltage of the power supply device 31 for use with the timing unit 35. The power supply device 31 is connected to a control interface device 33 and a start timing interface 34 simultaneously. The control interface device 33 is connected to a motor 36. When the switch position of the control interface device 33 is adjusted, the timing unit 35 is started to control the operation time of the motor 36. Alternatively, the operation of the motor 36 is not affected by the timing unit 35.

When the timing unit 35 is started to control the operation time of the motor 36, the electric power from the power supply device 31 is interrupted after the preset time of the timing unit 35 is reached, so that the motor 36 stops operating. Thus, the motor 36 stops operating when the preset time of the timing unit 35 is reached even if the user still presses the power switch. Thus, the motor 36 stops operating when the preset time of the timing unit 35 is reached so as to fix the output torque of the motor 36 at a constant value exactly to prevent the error of the manual control operation, so that the screw of the tire is locked exactly by the constant output torque of the motor 36 and will not be too tight or too loose.

Referring to FIG. 2, the electric power of the power supply device 31 is supplied by the auxiliary power of a car or by a chargeable battery. The power converter system 32 uses the IC1 (7808) to convert the voltage of the power supply device 31 into eight volts (8 volts) for use with the IC2 of the timing unit 35.

In operation of the control interface device 33, when the switch SW is pushed toward the T side, the switch legs 1 and 2 are connected, and the switch legs 5 and 6 are connected, so that the Q20N, Q30N, Q10FF and IC2 are started to calculate the time, and the motor 36 is started. After the preset time (N second) of the timing unit 35 is reached, the Q10N and Q20FF are started, and the electric power from the power supply device 31 is interrupted, so that the motor 36 stops operating. Alternatively, when the switch SW is pushed toward the L side, the switch legs 2 and 3 are connected, and the switch legs 4 and 5 are connected, so that the Q20N, Q30FF and Q10FF are started, and the motor 36 is started without being affected by the timing unit 35.

The start timing interface 34 includes R3, C2, R4, Q3 and R5. Thus, when the switch SW is pushed toward the T side, a voltage is produced and is filtered by the R3 and the C2. Then, the R4 drives the Q3, so that the Q3 is started (disposed at the “ON” state) to start the timing unit 35.

The timing unit 35 includes R6, R7, C3 and IC2. Thus, after the timing unit 35 is started, the electric power from the power supply device 31 is interrupted after the preset time (N second) of the timing unit 35 is reached (the Q10N and Q20FF are started), so that the motor 36 stops operating.

In conclusion, the operation time of the motor 36 is preset by an adjusting knob (not shown) so that the operation time of the motor 36 is preset according to the user's practical requirement. Thus, the electric power from the power supply device 31 is interrupted automatically and the motor 36 stops operating when the preset time of the timing unit 35 is reached so as to fix the output torque of the motor 36 at a constant value exactly to prevent the error of the manual control operation, so that the screw of the tire is locked exactly by the constant output torque of the motor 36 and will not be too tight or too loose, thereby preventing the tire from being worn out due to the screw of the tire being too tight or too loose so as to protect the drive's safety.

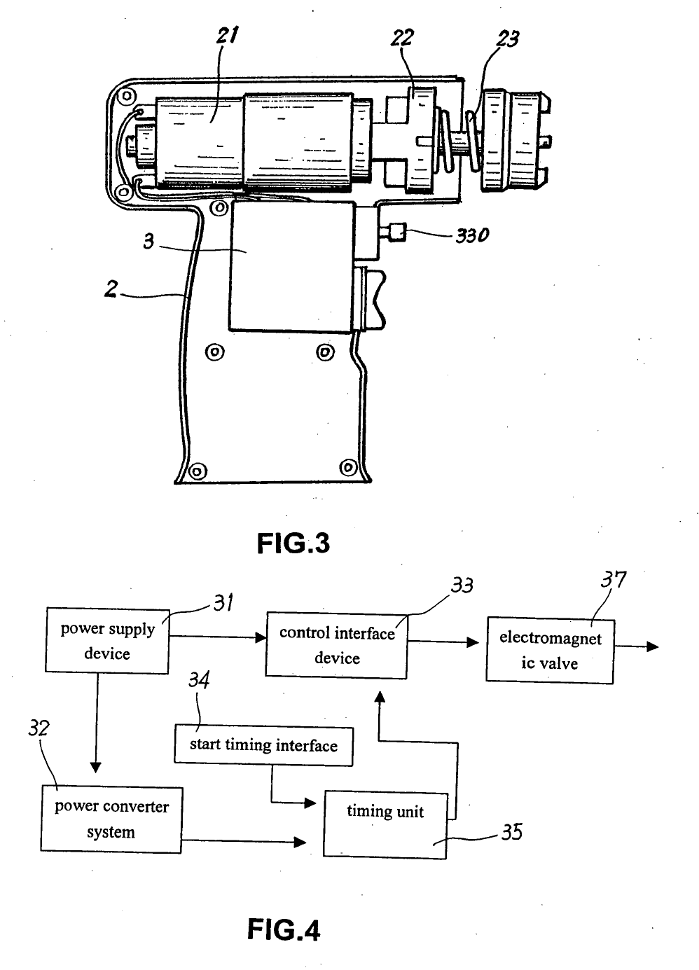

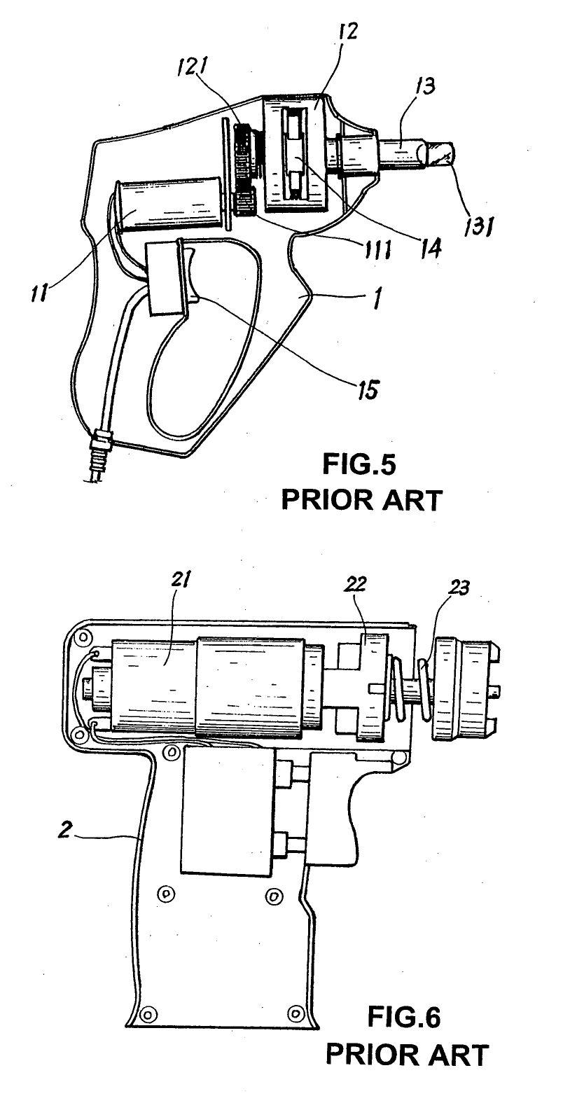

Referring to FIG. 3, the power line of the motor is connected to a self interruption system 3 of the power tool. Thus, when the position of the switch 330 is adjusted, the control interface device 33 is controlled to start the timing unit 35, so that the electric power from the power supply device 31 is interrupted automatically and the motor stops operating when the preset time of the timing unit 35 is reached so as to set the output torque of the motor 36 at a constant value exactly to prevent the error of the manual control operation.

Accordingly, the power tool comprises a control interface device to start the timing unit, so that the electric power from the power supply device is interrupted automatically and the motor stops operating when the preset time of the timing unit is reached so as to keep the output torque of the motor at a constant value exactly, thereby preventing from incurring errors of the manual control operation. In addition, the output torque of the motor is maintained at a constant value exactly, so that the screw of the tire is locked exactly by the constant output torque of the motor and will not be too tight or too loose, thereby preventing the tire from being worn out due to the screw of the tire being too tight or too loose so as to protect the drive's safety.

Referring to FIG. 4, the power tool is a pneumatic wrench which comprises an electromagnetic valve 37 to control and transmit the impact mechanism (the motorized wrench uses the motor to control and transmit the impact mechanism). The control interface device 33 is connected to the electromagnetic valve 37 to open or close the electromagnetic valve 37. The electromagnetic valve 37 is used to transmit a high pressure air into the pneumatic wrench to achieve the striking and pressing purpose. Thus, the electric power from the power supply device 31 is interrupted automatically and the electromagnetic valve 37 is closed when the preset time of the timing unit 35 is reached so as to set the output torque of the motor 36 at a constant value exactly to prevent the error of the manual control operation. In comparison, the motorized wrench is used to control operation of the motor, and the pneumatic wrench is used to open or close the electromagnetic valve 37.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A power tool, comprising:
a housing;
a motor mounted in the housing;
an output shaft mounted in the housing;
a driving device mounted in the housing and connected to the motor and the output shaft;
a switch mounted on the housing;
a control interface device mounted between the motor and the switch; wherein
the control interface device starts a timing unit so that an electric power supplied to the motor is interrupted after a preset time of the timing unit is reached, and the motor stops operating;
the preset time of the timing unit is proportional to an output torque of the motor.

2. The power tool in accordance with claim 1, wherein the preset time of the timing unit is adjusted by an adjusting knob so that the preset time of the timing unit is determined according to a user's practical requirement.

3. The power tool in accordance with claim 1, wherein the control interface device is available for a motorized wrench.

4. The power tool in accordance with claim 1, wherein the control interface device is available for a pneumatic wrench.

5. The power tool in accordance with claim 4, further comprising an electromagnetic valve connected to the control interface device to drive the control interface device to start the timing unit so that the motor closes the electromagnetic valve after the preset time of the timing unit is reached to stop operation of the pneumatic wrench.

6. The power tool in accordance with claim 1, wherein the control interface device is available for other power tools.
